(19) United States
(12) Patent Application Publication
(10) Pub. No.: US 2014/0026475 A1
(43) Pub. Date: Jan. 30, 2014

(54) Flower Pot Protection Device

(71) Applicant: Alejandro Centeno, Mineola, NY (US)

(72) Inventor: Alejandro Centeno, Mineola, NY (US)

(21) Appl. No.: 13/556,290

(22) Filed: Jul. 24, 2012

(51) Int. Cl. A01G 13/02

(52) U.S. Cl. 47/29.5

(57) ABSTRACT

The protection device is constructed of four main components, namely a base, a telescopic pole mounted on the base, a bendable arm secured to the pole and an umbrella assembly secured to the bendable arm. The base is sized and weighted to be placed in a container, such as a flower pot, in which a plant is to be grown.

This invention relates to a flower pot protection device. More particularly, this invention relates to a flower pot protection device for protecting plants grown in flower pots.

As is known, container gardening for most types of annual plants, both flowering and edible, is challenging and frustrating to gardeners because items planted within a confined, slow-draining space, are prone to root-rot, caused from an over-saturation from precipitation; burnt foliage caused by a combination of excessive sun exposure, and a weak root system, and wind damage caused by excessive wind gusts. The roots of plants planted within a container are subjected to twice the heat of plants planted in a regular bed. In addition, container gardening is very often used by gardeners in small confined spaces, quite often on exposed balconies or terraces at high elevations, where wind speeds are increased and sun intensity is magnified.

Accordingly, it is an object of the invention to provide a protection device for a flower pot used in growing plants that can effectively protect a growing plant from excessive rain, wind and sun.

It is another object of the invention to protect a growing plant in a confined container from excessive rain, wind and sun.

It is another object of the invention to provide a protection device that is economical to use.

It is another object of the invention to provide a protection device for growing plants that can be used in confined places.

Briefly, the invention provides a flower pot protection device comprised of a base for disposition in a flower pot; an upstanding pole mounted on the base on a vertical axis, a bendable arm secured to the pole and an umbrella assembly secured to the bendable arm.

The flower pot protection device is constructed as an adjustable, removable and re-useable protection device capable of fitting most free-standing pots, planters and containers, or used as a table-top apparatus.

The base can vary in geometry and mass depending on the size and configuration of the pot/container. The weighted base also allows the assembly to be used as a table-top apparatus for protecting mainly food items exposed “to excessive sun, rain or wind conditions.

The base is typically in the form of a heavy base plate and is used to hold the pole upright while adding stability to the pot. In this regard, the base has an internally threaded bore and the pole is threaded into the bore.

The pole is made as a telescopic shaft of two sections that are coupled together by an adjustable coupling so that the length of the shaft can be adjusted depending on the height of the pot and the height of the items to be grown in the pot. The telescopic shaft allows a user to adjust the height of the pole to extend to whatever height desired above the level of soil in the pot.

The bendable arm is removably secured to the pole and is composed of a steel coil that allows for the umbrella to be positioned at different angles with respect to the vertical axis of the pot and the telescopic shaft. The bendable arm is sufficiently strong to maintain the pitch at which it is set, withstanding wind gusts of up to 30 mph.

The bendable arm includes a plastic snap-on connector having a pair of resiliently mounted buttons, a flexible adjustable rubber coated shaft (e.g. in the manner of a gooseneck) extending from the connector and a second connector extending from the shaft on the opposite end. The snap-on connector connects the bendable arm to the telescopic shaft while the other connector connects the bendable arm to, the umbrella assembly. In this regard, the pole has an upper section defining a hollow cavity and a pair of slots communicating with the cavity with the resiliently mounted buttons releasably engaged in the slots to retain the bendable arm in the upper section of the pole.

The umbrella assembly includes a shaft, a collapsible skeletal frame for movement between a collapsed position about the shaft and a raised position extending radially outwardly of the shaft, and a cover disposed on the frame for movement therewith between a collapsed position about the shaft and an outwardly splayed position relative to the shaft.

The shaft of the umbrella assembly includes an internally threaded insert for threading onto an externally threaded stem in a bore in the bendable arm.

The telescopic pole and the base plate are waterproof and made of materials with no leaching properties.

The protection device basically provides an umbrella that is connected onto a planted, subterranean adaptable assembly, by means of a bendable arm. The bendable arm allows for the umbrella to be angled in any direction, up to 120 degrees from the vertical axis of the telescopic pole to which the umbrella is connected in order to shield the contents of a pot or container from the prevailing weather conditions. The bendable arm and the umbrella can be removed from the assembly once weather conditions improve.

The protection device may also be provided with a rain cloak to protect a plant from rain or other precipitation. For example, the rain cloak is sized to be disposed over the umbrella assembly and has a tie for securing the cloak peripherally about a pot.

These and other objects and advantages of the invention will become more apparent from the following detailed description taken in conjunction with the accompanying drawings in which:

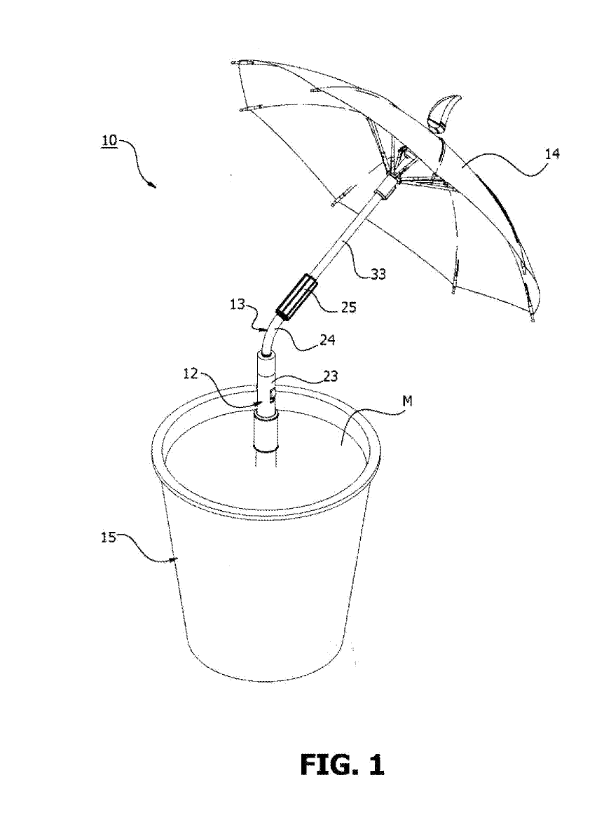

FIG. 1 illustrates an isometric view of a protective device in accordance with the invention inside a flower pot;

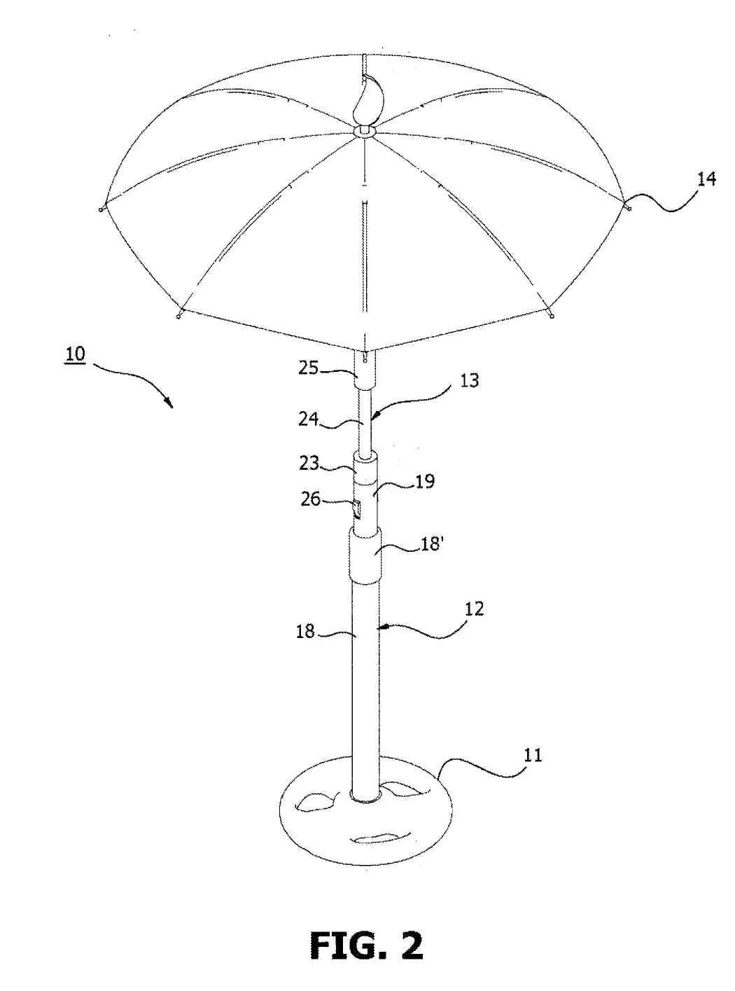

FIG. 2 illustrates an isometric view of a protective device in accordance with the invention;

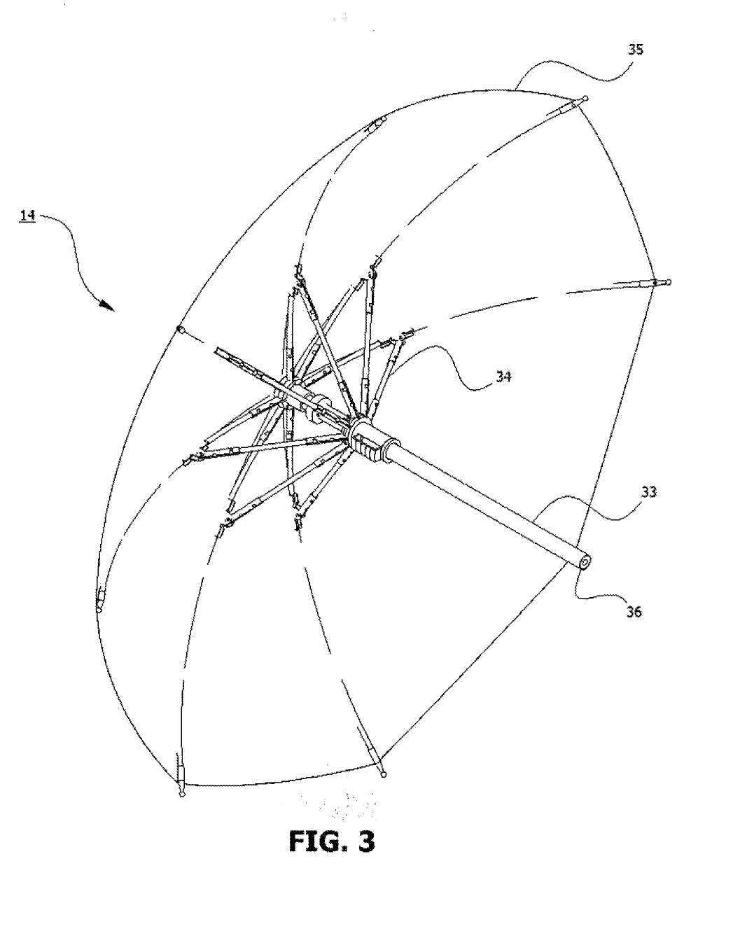

FIG. 3 illustrates an isometric view of an umbrella assembly of the protective device;

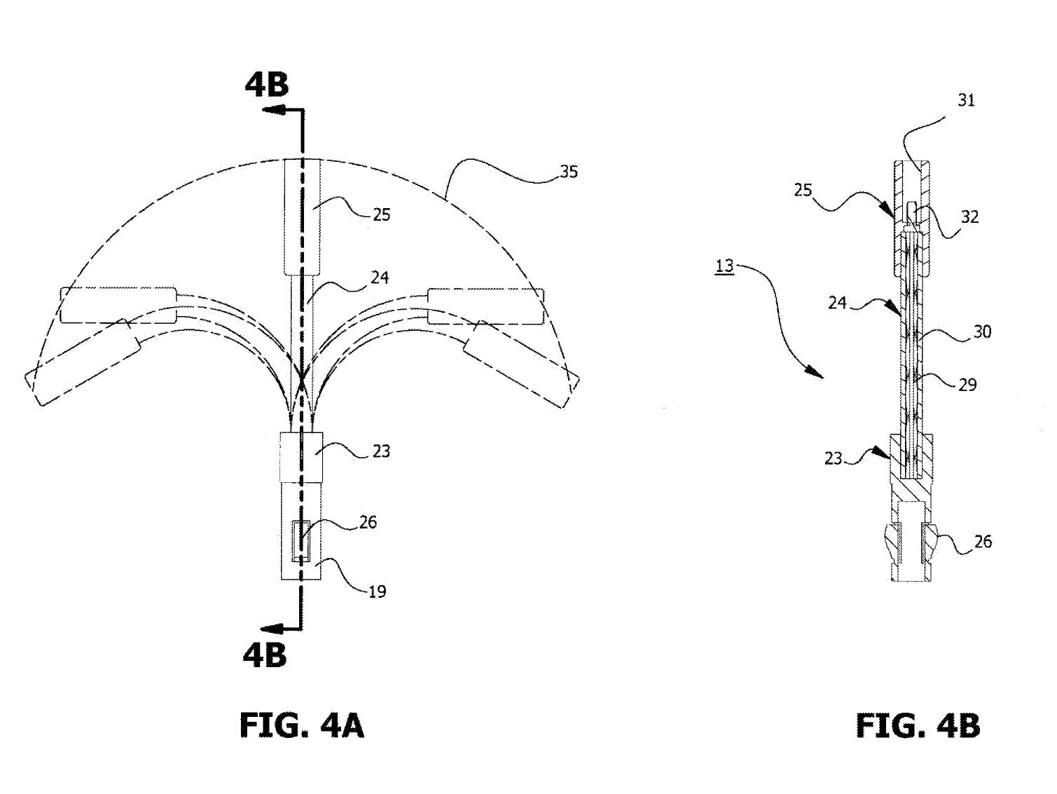

FIG. 4A illustrates a schematic side view of the bending arm of the protective device bent at four different positions.

FIG. 4B illustrates a cross-sectional view of the bending arm taken on line 4B-4B of FIG. 4A;

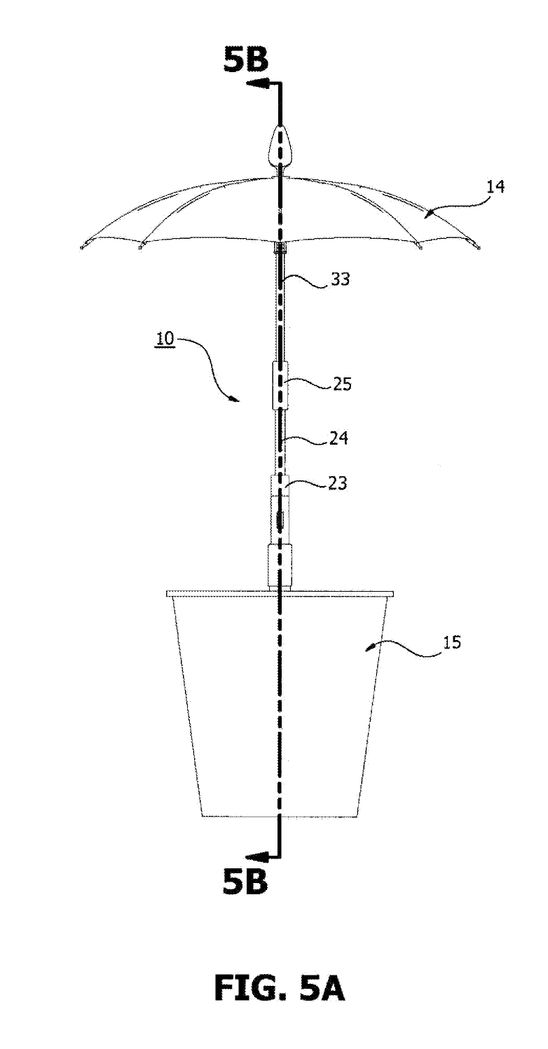

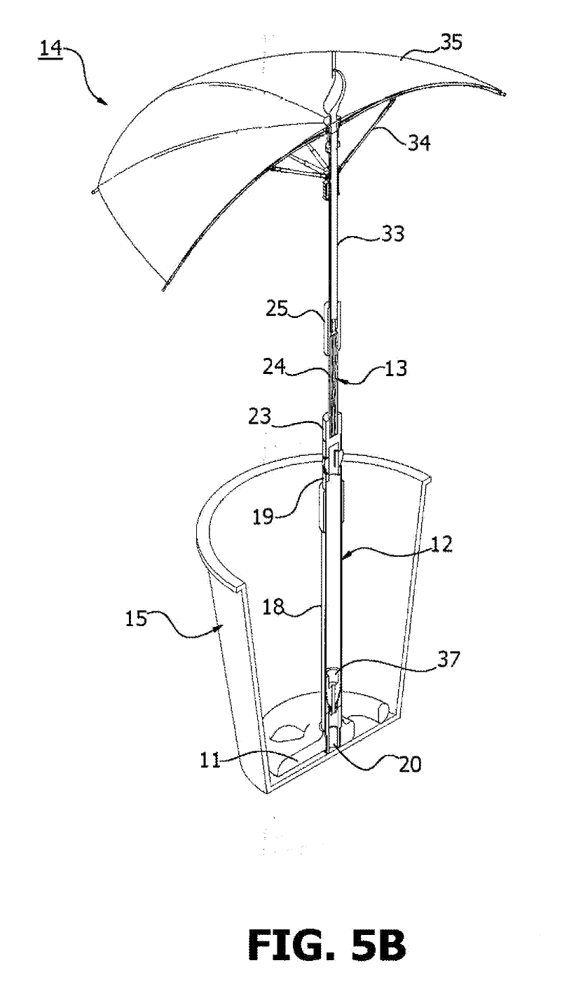

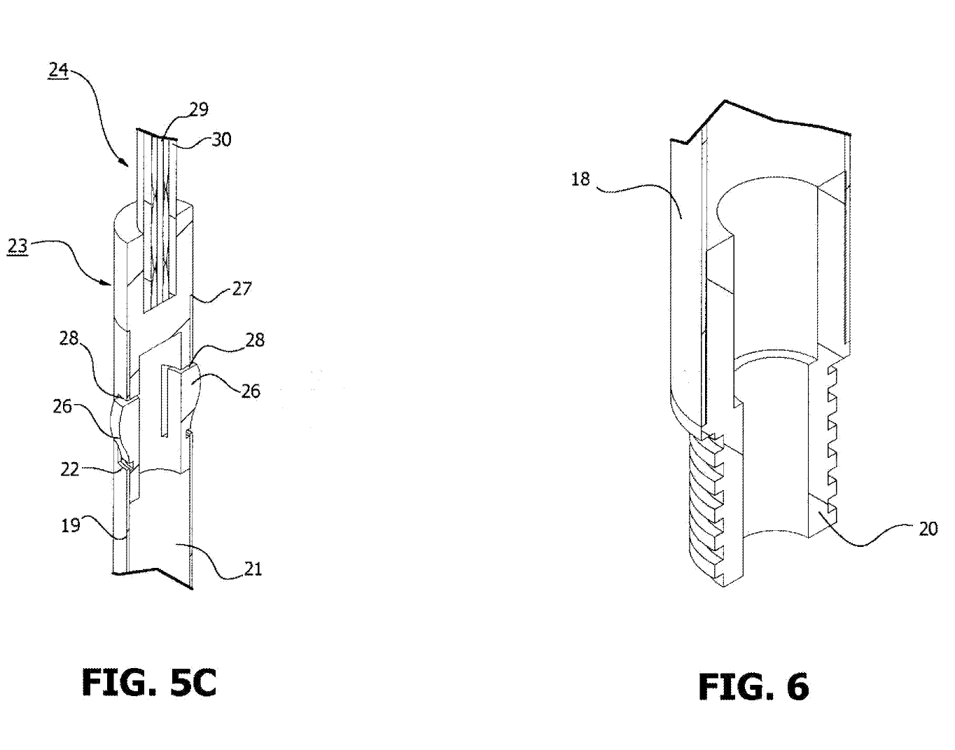

FIG. 5A illustrates a schematic side view of a protective device in accordance with the invention inside a flower pot;

FIG. 5B illustrates a cross-sectional view of the protective device in a flower pot taken on line 5B-5B of FIG. 5A;

FIG. 5C illustrates a part perspective view of the connection between the top of the pole and the bendable arm in accordance with the invention;

FIG. 6 illustrates an isometric cross-sectional view of the lower end of the pole;

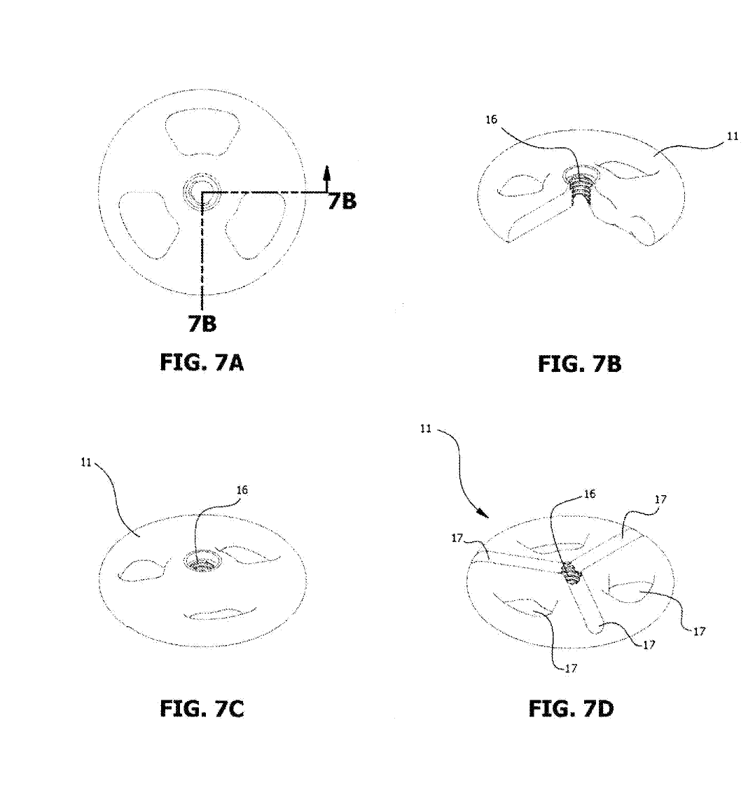

FIG. 7A illustrates a top view of the base of the protective device;

FIG. 7B illustrates an isometric cross-sectional view of the top side of the base of FIG. 7A taken on line 7B-7B of FIG. 7A;

FIG. 7C illustrates an isometric view of the base of FIG. 7A;

FIG. 7D illustrates a bottom view of the base plate of FIG. 7A;

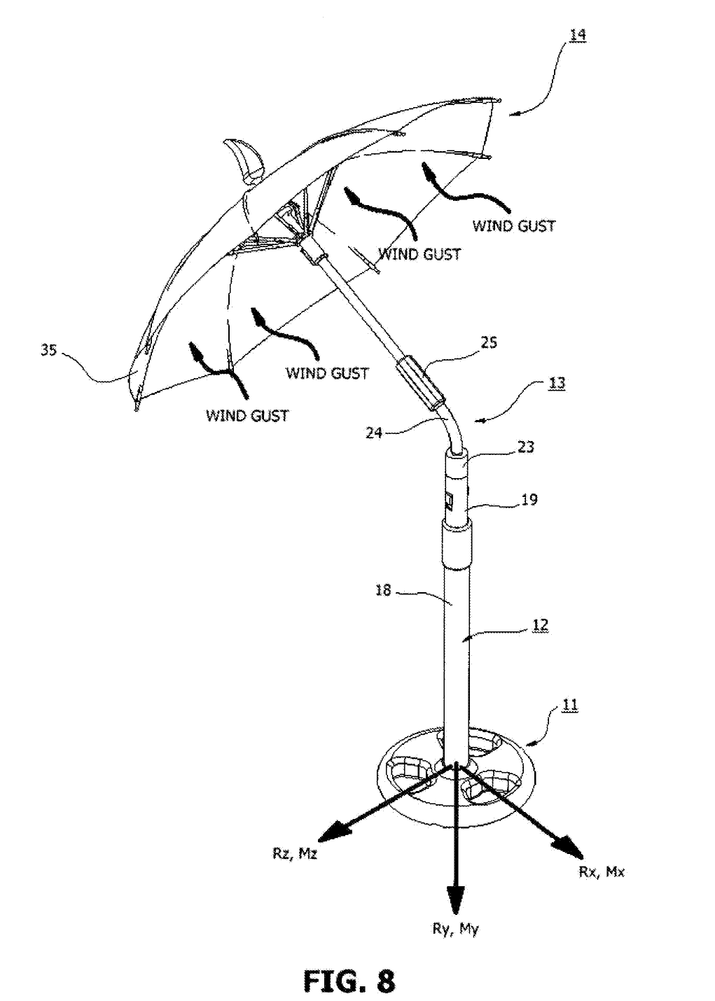

FIG. 8 illustrates a perspective view of the protective device relative to a wind gust;

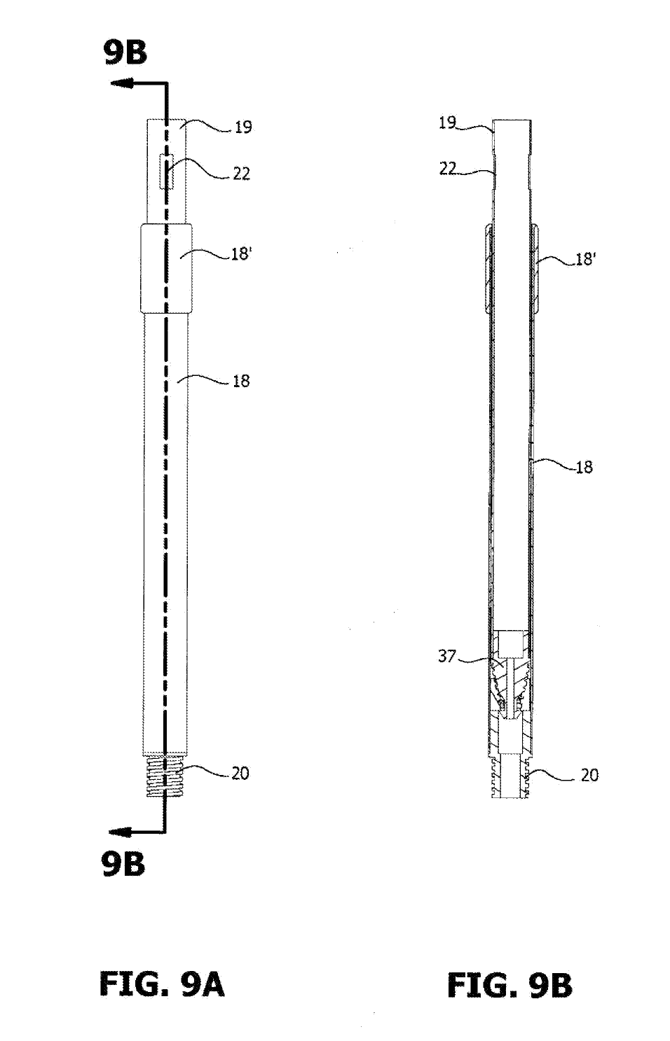

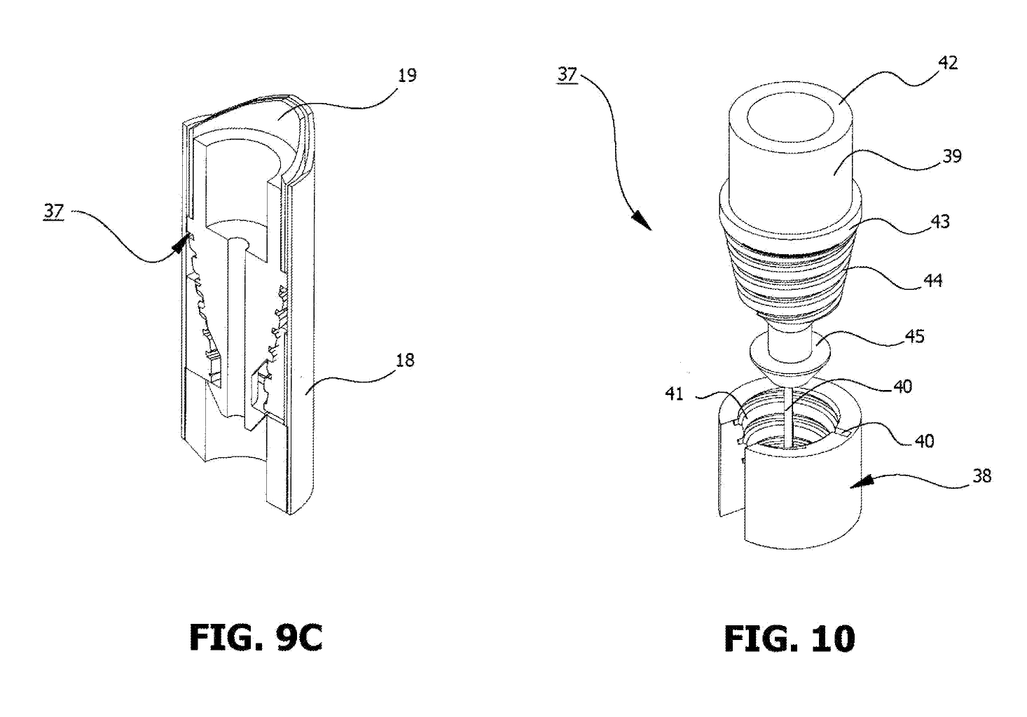

FIG. 9A illustrates a side view of a telescopic shaft in accordance with the invention;

FIG. 9B illustrates a cross-sectional view of the shaft of FIG. 9A taken on line 9B-9B of FIG. 9A;

FIG. 9C illustrates a part perspective view of the coupling in the shaft of FIG. 9B;

FIG. 10 illustrates an exploded view of the coupling of FIG. 9C;

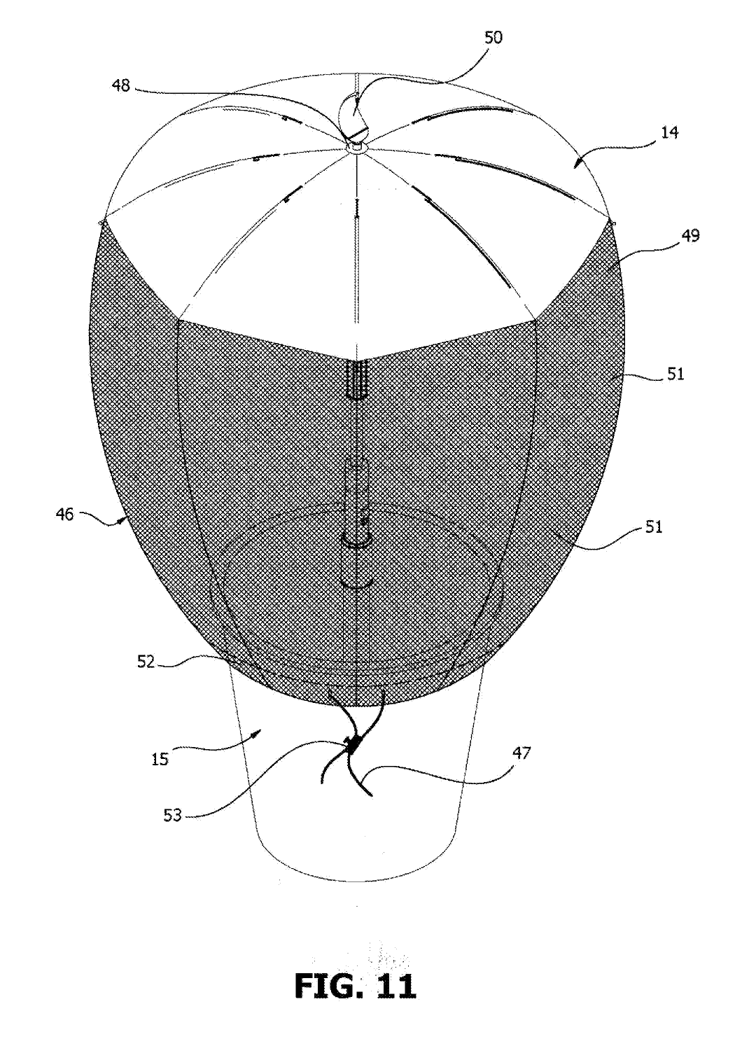

FIG. 11 illustrates a perspective view of a rain cloak secured in place over the protective device and flower pot of FIG. 1;

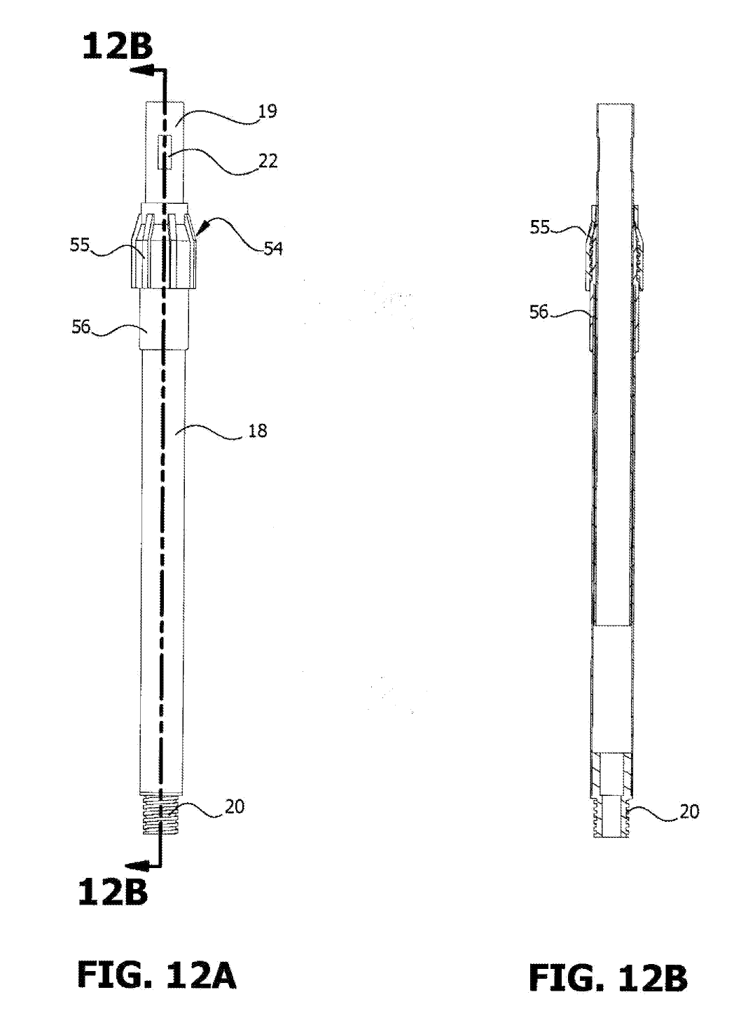

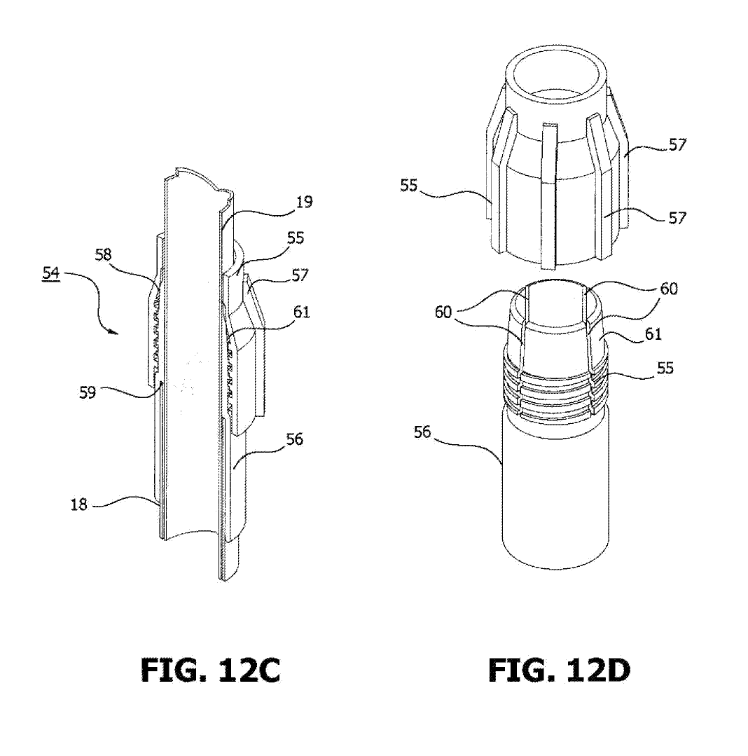

FIG. 12A illustrates a side view of a modified telescopic shaft in accordance with the invention;

FIG. 12B illustrates a cross-sectional view of the shaft of FIG. 12A taken on line 12B-12B of FIG. 12A;

FIG. 12C illustrates a part perspective view of the coupling in the shaft of FIG. 12B; and

FIG. 12D illustrates an exploded view of the coupling of FIG. 12C; and

Referring to FIG. 2, the protection device 10 is constructed of four main components, namely a base 11, a pole 12 mounted on the base, a bendable arm 13 secured to the pole 12 and an umbrella assembly 14 secured to the bendable arm 13 about a vertical axis.

Referring to FIG. 1, the protection device 10 is sized to be inserted into a container 15, such as a flower pot. The container 15 may also be of any other shape suitable for growing plants particularly for growing plants in a confined space, such as on a balcony or terrace. After positioning of the protection device 10 in the container 15, a suitable growing medium M, such as potting soil, is filled into the container 15 over the base 11 and about the pole 12 of the protection device. A suitable plant (not shown) may also be potted in the medium M.

Referring to FIGS. 7A, 7B, 7C and 7D, the base 11 is in the form of a circular base plate and is of a weighted material so as to provide stability to the protection device 10 of FIG. 2 when placed in a container such as illustrated in FIG. 1, particularly with respect to wind gusts and heavy precipitation.

As illustrated, the base 11 includes a centrally located internally threaded bore 16 formed of galvanized steel to prevent rusting.

Referring to FIG. 7D, the underside of the base 11 has a plurality of grooves 17, e.g. three grooves, for channeling water away from the telescopic pole 12. When the telescopic pole 12 is in place in the soil in a pot 15 and no bendable arm 13 or umbrella assembly 14 are attached, rain or irrigation water can, and will, descend down the hollow cavity of the pole 12 and exit through a small hole at the bottom. The water therefore has three grooves (channels) 17 to flow through to holes in the pot 15. The grooves 17 will also help with the dispersing of any water accumulating at the bottom of the pot 15 due to watering or precipitation.

Referring to FIG. 5B, the pole 12 is formed of two sections 18, 19 that telescope together so that the pole may be extended to a desired length.

Referring to FIG. 6, the bottom section 18 of the pole 12 has an externally threaded plastic tip 20 secured in the bottom for threading into the threaded bore 16 of the base 11. The tip 20 is hollow to allow water to drain out of the pole 12.

Referring to FIG. 5C, the top section 19 of the pole 12 has a hollow cavity 21 and a pair of slots 22 that communicate with the cavity 21.

Referring to FIGS. 4A and 4B, the bendable arm 13 is formed of three parts, namely a plastic snap-on connector 23, a flexible adjustable rubber coated shaft 24 extending from the connector 23 and a second connector 25 extending from the shaft 24 at an opposite end.

Referring to FIG. 5C, the plastic snap-on connector 23 is shaped and sized to slide into the cavity 21 in the top section 19 of the pole 12. In addition, the snap-on connector 23 has a pair of resiliently mounted buttons 26 that engage within the respective slots 22 of the top section 19 of the pole 12. As indicated, when the plastic connector 23 is slid into the top section 19 of the pole 12, the buttons 26 are pushed inwardly to slide inside the top section 19 of the pole 12 and then “pop out” when reaching the slots 22.

As illustrated in FIG. 5C, the plastic connector 23 has a step 27 with an outer diameter equal or larger than the inner diameter of the top section 19 of the pole 12. The distance from this step 27 to the top of the buttons 26 is the same as the distance from the top of the pole 12 to the top surface of the rectangular slots 22. When the plastic connector 23 is fully inserted into the pole 12, each button 26 has a flat top 28 that comes in contact with the top of a rectangular slot 22. At the same time, the step 27 on the plastic connector 23 sits flat on the top surface of the pole 12. The flexibility of the buttons 26 allows each to spring back to the original shape. The plastic connector 23 may not be removed once fitted in place. Pressure must be applied to the two buttons 26 to flex inward so that the buttons 26 will not come in contact with the flat surfaces of the rectangular slots 22. As the buttons 26 protrude past the outer diameter of the pole 12, damage to a user's fingernails can be avoided when pushing the buttons 26 inward.

The flexible adjustable shaft 24 is formed of a coil of wire 29 within a plastic cover 30. As illustrated in FIGS. 4B and 5C, the flexible shaft 24 is fitted into a bore of the plastic connector 23 and is typically molded, in place.

The shaft 24 is characterized in being tiltable in any direction up to an angle of 120° with respect to the vertical axis of the pole 12. The shaft 24 is able to keep its shape once bent and is rigid enough to withstand wind gusts of up to 30 miles per hour while retaining its shape. FIG. 4A schematically illustrates the range of, motion of the shaft 24 and, thus, the bendable arm 13.

Referring to FIG. 4B, the upper connector 25 of the bendable arm 13 is also made of plastic and is molded to the shaft 24 so that the bendable arm 13 is of one piece construction. As illustrated, the connector 25 has a bore 31 at the upper end for receiving the umbrella assembly 14 as well as an externally threaded stem 32 recessed within the connector 25 on the longitudinal axis of the bendable arm 13.

Referring to FIG. 3, the umbrella assembly 14 includes a shaft 33, a collapsible skeletal frame 34 and a cover 35. The skeletal frame 34 is constructed for movement between a collapsed position about the shaft 33 and a raised position, as shown, extending radially outwardly of the shaft 33. The cover 35 is disposed on the frame 34 for movement therewith between a collapsed position about the shaft 33 and an outwardly splayed position, as shown, relative to the shaft 33.

The umbrella assembly 14 is of a generally conventional structure; however, the skeletal frame 34 uses fiberglass or carbon-fiber ribs that are more flexible and durable than conventional ribs in order to be able to withstand wind gusts for a long period of time. In addition, specially modified wind vents may be provided to allow for wind accumulation under the umbrellas to pass through, since these umbrellas may be exposed to long periods of windy weather.

Also, the umbrella shaft 33 includes an internally threaded insert 36, for example, of brass, at the lower end.

Referring to FIG. 5B, the shaft 33 of the umbrella assembly is sized to slide into the cavity 31 of the connector 25 of the bendable arm 13 with the insert 36 threaded onto the stem 32 within the threaded connector 25. In this respect, the umbrella assembly 14 may be readily screwed into place and unthreaded for removal as desired. This also allows different sizes of umbrella assemblies to be accommodated by the bendable arm 13, for example, depending upon the size of the container 15, the umbrella assembly 14 may have a cover 35 of greater or lesser size.

Referring to FIGS. 9B and 9C, the two sections 18, 19 of the telescopic pole 12 are secured together by an adjustable coupling 37. As indicated in FIG. 9B, the lower section 18 carries a sleeve 18′ at the upper end to facilitate passage of the upper section 19 into the lower section 18.

Referring to FIG. 10, the coupling 37 is formed of two parts, namely, an internally threaded and split plastic sleeve 38 and an externally threaded plastic plug 39 that threads into the sleeve 38.

As illustrated, the exterior of the sleeve 38 is sized of a diameter to slide into the upper end of the bottom section 18 of the pole 12 in a slide fit relation and the interior of the sleeve 38 is of conical shape. In addition, the interior of the sleeve 38 has a pair of longitudinal slots 40 that segment the internal thread 41 of the :sleeve 38 into partial segments.

The plug 39 is formed with a hollow cylindrical portion 42 of a diameter to slide into the lower end of the top section 19 of the pole 12 and be fixed in place, a cylindrical collar 43 sized to abut against the lower end of the top section of the pole 12 and to slide into the upper end of the bottom section 18 of the pole 12, an external conical thread 44, depending from the collar 42, as viewed, and a guide 45 depending from the thread 44.

As shown in FIG. 10, the guide 45 has a rounded cap of smaller diameter than the thread 44 and the sleeve 38 so as to pass through the sleeve 38 when the plug 39 is fully inserted in the sleeve 38. The purpose of the round cap is to hold the sleeve 38 so that the sleeve 38 is not lost within the pole 12. The top surface of the guide 45 pushes against the bottom surface of sleeve 38 when the length of the telescopic pole 12 is adjusted.

The external thread 44 engages with the internal thread 41 when the top section 19 of the telescopic pole 12 is rotated. The friction force between the sleeve 38 and the bottom section 18 of the telescopic pole 12 acts in an opposite direction to the rotation of the top section, ‘19, thus allowing the external thread 44 to engage with the internal thread 41. It is important to note that the external and internal threads are tapered. As the external thread 44 engages with the internal thread 41 of the sleeve 38, the diameter of the plug 39 increases with respect to the smallest diameter of the sleeve 38. This mechanism allows the sleeve 38 to expand within the bottom section, 18 of the telescopic pole 12.

During assembly of the pole 12, the coupling 37 is inserted into the lower end of the top section 19 and fixed in place against rotation relative to the top section 1.9. Thereafter, the two sections 18, 19 are telescoped together with the coupling 37 sliding into the bottom section 18. Once the desired length of the pole 12 is obtained, the top section 19 is rotated, for example, clockwise relative to the bottom section 18 (or vice versa). This causes the plug 39 to rotate relative to the sleeve 38 since the sleeve 38 is held in a tight fit manner in the bottom section 18. As the plug 39 rotates relative to the sleeve 38, the sleeve 38 begins to expand diametrically thereby increasing the frictional force between the plastic sleeve 38 and metal bottom section 18 from a slidable tight fit to a fixed friction fit.

In order to change the length of the pole 12, the two pole sections 18, 19 are rotated in opposite directions to release the gripping force of the coupling 37 so that the sections may be readjusted to each other and again secured in place.

Referring to. FIG. 7B, the depth of the counterbore 16 in the base 11 provides a surface area on which the bottom section 18 of the telescopic pole 12 rests. When the protection device 10 is in use, wind gusts and heavy precipitation apply pressure on the cover 35 of the umbrella assembly 14. This pressure generates a moment with respect to the bottom section 18 of the telescopic pole 12. The weight of the base 11 provides reaction forces in the vertical and horizontal directions, as well as a reaction moment of equal magnitude but opposite direction as the moment generated by a wind gust, thus keeping the protection device in static equilibrium.

FIG. 8 is a free-body diagram of the reaction forces on the telescopic pole 12 exerted by a wind gust and the base 11.

Referring to FIG. 11, wherein like reference characters indicate like parts as above, a rain cloak 46 is disposed over the umbrella assembly 14 and is secured peripherally about the pot 15 by a tie 47.

The cloak 46 is formed with a centrally disposed ring 48 for mounting on the shaft 33 of the umbrella assembly 14 and a perforated cover 49 extending radially from said ring 48 and having the tie 47 extending therethrough. For example, the ring 48 of the cloak 46 fits about an externally threaded stem (not shown) at the top of the umbrella shaft 33 which receives a ferrule or finial 50 in a conventional manner: When threaded onto the stem, the finial 50 holds the ring 48 in place.

The perforated cover 49 may be made of plastic to keep rain from entering under the umbrella assembly 14 and with small holes 51 for the passage of air.

The perforated cover 49 may be fabricated as a circular piece with a radial slit (not shown) extending from the ring 48 to the outer edge of the cover 49 to allow the cover to be draped over the umbrella assembly 14 and pot 15 in a ballooned manner as shown.

The tie 47 is threaded through a hem 52 about the outer peripheral edge of the cover 49 and has two free ends that can be tied together in the manner of a drawstring and secured using a cord lock 53 in order to secure the cover 49 about the pot 15.

Referring to FIGS. 12A to 12D, wherein like reference characters indicate like parts as above, the two telescoping sections 18, 19 of the pole 12 may be adjustably coupled together by an externally actuated coupling 54.

Referring to FIGS. 12C and 12D, the coupling 54 is formed of two parts, namely an internally threaded sleeve 55 and an externally threaded sleeve 56 that threadably engage with each other.

As illustrated, the internally threaded sleeve 55 has a plurality of longitudinally extending external ribs 57 to facilitate manual gripping thereof and a conical inner surface 58 (FIG. 12C) at an intermediate, portion of the length of the sleeve 55.

As illustrated, the externally threaded sleeve 56 is press-fitted to the upper end of the bottom section 18 until the surface of an internal annular shoulder 59 sits flush with the top surface of the bottom section 18 (FIG. 12C). The externally threaded sleeve 56 also has two pairs of longitudinal slots 60 that segment the sleeve 56 into partial segments as well as a conically tapered surface 61 at the terminal end.

During, assembly of the pole 12, the two sections 18, 19 are telescoped together by sliding the top section 19 through the internally threaded sleeve 55 and through the externally threaded sleeve 56 press-fitted to the bottom section 18 until the desired length of the pole 12 is obtained. The internally threaded sleeve 55 is then rotated clockwise relative to the, bottom section 18. The gripping force of the internally threaded sleeve 55 causes the conical inner surface 58 of the, sleeve 55 to press against the conically tapered surface 61 of the sleeve 56 thereby forcing the segments of the externally threaded sleeve 56 to contract until the friction forces between segments of the sleeve 56 and the outside surface of the top section 19 are large enough to counteract tensile forces that would prevent the pole 12 from maintaining a desired length.

The invention thus provides a protection device that can effectively protect a plant growing in a confined space, such as a flower pot or other container from excessive rain, wind and sun.

The protection device can be incorporated into all sizes of free-standing pots and containers as different sizes of umbrella assemblies and adjustable poles can be fitted into the base plate. The different size of umbrella assemblies can cover small or large diameter pots. The adjustable different size telescopic poles can be used in tall or short free-standing flower pots.

The umbrella assembly can also be used for decorative promotional and advertising purposes for commercial businesses by adding advertising/logo imprinting onto the material of the umbrella cover.

1. A flower pot protection device comprising
a base for disposition in a flower pot;
an upstanding pole mounted on said base on a vertical axis;
a bendable arm secured to said pole on said vertical axis; and
an umbrella assembly secured to said bendable arm on said vertical axis.

2. A flower pot protection device as set forth in claim 1 wherein said base has an internally threaded bore and said pole is threaded into said bore.

3. A flower pot protection device as set forth in claim 1 wherein said pole has a pair of sections telescopically disposed in each other and an adjustable coupling securing said sections together.

4. A flower pot protection device as set forth in claim 3 wherein said coupling includes a split plastic sleeve slidably mounted in one of said pair of sections and an externally-threaded plastic plug fixed in an end of the other of said pair of sections and threaded into said sleeve.

5. A flower pot protection device as set forth in claim 3 wherein said coupling includes an externally-threaded sleeve fitted to an end of a lower section of said pair of sections and having a conically tapered surface with a plurality of slots dividing said terminal end into segments and an internally-threaded sleeve threaded onto said externally-threaded sleeve and having a conical inner surface pressed against said segments to frictionally engage said segments with an upper section of said pair of sections.

6. A flower pot protection device as set forth in claim 1 wherein said bendable arm is removably secured to said pole.

7. A flower pot protection device as set forth in claim 6 wherein said pole has an upper section defining a hollow cavity and a pair of slots communicating with said cavity and wherein said bendable arm includes a pair of resiliently mounted buttons releasably engaged in said slots to retain said bendable arm in said upper section of said pole.

8. A flower pot protection device as set forth in claim 7 wherein said bendable arm includes a first connector having said pair of buttons thereon, a flexible adjustable shaft extending from said first connector and a second connector extending from said shaft on an end opposite said first connector.

9. A flower pot protection device as set forth in claim 1 wherein said bendable arm has a connector at one end and said umbrella assembly is threadably mounted in said connector.

10. A flower pot protection device as set forth in claim 1 wherein said umbrella assembly includes a shaft disposed on said vertical axis, a collapsible skeletal frame for movement between a collapsed position about said shaft and a raised position extending radially outwardly of said shaft, and a cover disposed on said frame for movement therewith between a collapsed position about said shaft and an outwardly splayed position relative to said shaft.

11. A flower pot protection device as set forth in claim 10 wherein said shaft of said umbrella assembly includes an internally-threaded insert threaded into said bendable arm.

12. A flower pot protection device as set forth in claim 11 wherein said bendable arm has a connector at one end having a bore receiving said shaft of said umbrella assembly and an externally-threaded stem in said bore threadably receiving said threaded insert of said umbrella assembly.

13. A flower pot protection device comprising
a base for disposition in a flower pot, said base having an internally;
threaded bore;
an upstanding pole threadably mounted in said bore of said base on a vertical axis, said pole having an upper section defining a hollow cavity and a pair of slots communicating with said cavity;
a bendable arm secured to said pole on said vertical axis, said arm including a first connector having a pair of buttons resiliently mounted thereon and projecting through said slots of said pole, a flexible adjustable shaft extending from said first connector and a second connector extending from said shaft on an end opposite said first connector; and
an umbrella assembly removably secured to said second connector of said bendable arm on said vertical axis.

14. A flower pot protection device as set forth in claim 13 wherein said umbrella assembly includes a shaft and an internally-threaded insert in said shaft and wherein said second connector has a bore receiving said shaft of said umbrella assembly and an externally-threaded stem in said bore threadably receiving said threaded insert of said umbrella assembly.

15. In combination,
a flower pot having a bottom and an upstanding wall defining a cavity for receiving soil; and
a protection device removably mounted in said flower pot, said protection device including a base disposed on said bottom of said flower pot, a pole mounted on said base on a vertical axis to pass upwardly through soil in said flower pot, a bendable arm secured to said pole above said wall of said flower pot; and an umbrella assembly secured to said bendable arm on said vertical axis, said umbrella assembly including a shaft, a collapsible skeletal frame for movement between a collapsed position about said shaft and a raised position extending radially outwardly of said shaft, and a cover disposed on said frame for movement therewith between a collapsed position about said shaft and an outwardly splayed position relative to said shaft to protect the contents of said flower pot.

16. The combination as set forth in claim 13 further comprising a rain cloak disposed over said umbrella assembly and having a tie for securing said rain cloak peripherally about said pot.

17. The combination as set forth in claim 16 wherein said cloak has a centrally disposed ring for mounting on said shaft of said umbrella assembly and a perforated cover extending radially from said ring, said cover having said tie extending therethrough.
